(19) United States
(12) Patent Application Publication
(10) Pub. No.: US 2025/0011240 A1
(43) Pub. Date: Jan. 9, 2025

(54) REFRACTORY PRODUCT AND ITS USE

(71) Applicants: Topsoe A/S, Kgs. Lyngby (DK); RHI Magnesita Bochum GmbH, Bochum (DE)

(72) Inventors: Johannes Ruben Larsen, Fredericia (DK); Fred Brunk, Hattingen (DE)

(73) Assignees: Topsoe A/S, Kgs. Lyngby (DK); RHI Magnesita Bochum GmbH, Bochum (DE)

(21) Appl. No.: 18/712,644

(22) PCT Filed: Nov. 23, 2022
(86) PCT No.: PCT/EP2022/082953

§ 371 Date: May 22, 2024

(30) Foreign Application Priority Data
Nov. 26, 2021 (DK) PA202101121

(51) Int. Cl. C04B 35/106

(52) U.S. Cl. CPC C04B 35/106; C04B 2235/3217; C04B 2235/3225; C04B 2235/3246; C04B 2235/5436; C04B 2235/5445; C04B 2235/764

(57) ABSTRACT

A shaped and fired coarse ceramic refractory product and a process for the preparation of the product and use the product, the shaped and fired coarse ceramic refractory product comprises (a) a chemical composition comprising a content of Al₂O₃: at least 40 wt.-%: Y₂O₃: 2.0-57 wt.-%; ZrO₂: below 42.0 wt.-%; and (b) a bond matrix comprising at least an yttria-containing crystalline mixed oxide with cubic modification cubic modification of the ternary system Al₂O₃—Y₂O₃—ZrO₂.

### FIELD OF THE INVENTION

The invention relates to an Al₂O₃ containing low SiO₂ coarse-ceramic fired refractory product comprising at least a crystalline yttria-containing mixed oxide phase with cubic modification of the ternary System Al₂O₃—Y₂O₃—ZrO₂ in the bond matrix, a method for producing thereof and the use of said product.

In the sense of the present invention, the term “Al₂O₃-containing” means an Al₂O₃-content of at least 40.0 wt. %.

As well known, coarse ceramic products are based on raw materials with grain sizes up to 6 mm and in special cases up to 25 mm. The three main structure components of these fired products are (scaffolding) grain, bond matrix and pores (ref. to G. Routschka and H. Wuthnow, “Handbook of Refractory Materials”, chapter 2, ISBN 978-3-8027-3162-4). In differentiation to coarse ceramic products, the structure of fine ceramic products exhibits, by definition, a grain that is smaller than 0.2 mm (appears homogeneous to the naked eye).

### BACKGROUND OF THE INVENTION

EP 0309091 B1 describes a refractory ceramic material formed from a mixture of yttrium oxide powder and aluminium oxide powder containing at least 70 mole % yttrium oxide and from 11 to 30 mole % aluminium oxide and consists mainly of monoclinic yttrium aluminium oxide (Y₄Al₂O₉, YAM). The fine ceramic opaque material having 5.3 to 16.2 wt. % Al₂O₃ is characterised by a structure without open pores and exhibits a resistance to molten rare earth-iron alloys. The isostatically pressed material is proposed for use as nozzle for casting molten metal.

Fine ceramic materials comprising alumina and yttria stabilized tetragonal zirconia and, if applicable, also additional monoclinic zirconia are known in engineering application as zirconia toughened alumina (ZTA) (e.g. U.S. Pat. No. 4,960,441 and EP 0300716 B1). Fine zirconia particles (typically 10-20 wt. %) are evenly dispersed in a μ-sized alumina matrix resulting in a more fracture resistant microstructure than alumina alone. When placed under stress, metastable tetragonal zirconia transforms to monoclinic phase, which takes place under volume expansion resulting in various toughening mechanisms.

For lining combustion chambers or furnaces with working temperatures above 1000° C. containing hydrogen (H₂) and carbon monoxide (CO), coarse-ceramic refractory alumina materials which in mineralogical terms mainly consist of alpha-Al₂O₃ (corundum) and exhibit a necessary low silica and iron content are notoriously used. It is well known that both SiO₂ and Fe₂O₃ are not stable under these reducing conditions. Consequently, raw-material basis for the production of these yttria-free materials are high purity granular synthetic fused and/or sintered corundum as well as powdery calcined alumina.

Chemically high pure and direct-bonded high-fired corundum bricks (>98 wt. % Al₂O₃) available on the market are characterized by a high thermal resistance and stability required for use under load at elevated temperature, which is measured in accordance with standards as refractoriness under load and creep in compression. For example, the typical application of these coarse ceramic materials as inner lining (“hot face”) of reactor pressure vessels for the production of syngas is based hereof. However, when reducing atmospheres containing carbon oxides, hydrogen and, in particular at least temporarily, steam are present at high temperatures, the alumina at the brick surface is chemically reduced to gaseous aluminium sub-oxides and/or aluminium hydroxide, whereby it is known that the alumina bond matrix of the brick is preferentially attacked. This alumina volatilization is characterized by an exponential growth with increasing temperature above 1100° C., and the maximum hot face temperature can be up to 1550° C. Typical temperatures of the hot face will be in the range of 1200-1400° C. Consequently, the most severely corrosion effect of volatilization occurs in the reactor vessel's upper part and can be directly measured as thickness loss or weight loss of the corundum material. As a result, the gaseous aluminous products migrate to cooler areas of the reactor and/or cooler surfaces in downstream process equipment. Here, they precipitate as aluminium oxide and form deposits, which is known to cause various considerable problems. In particular, deposits within the reactor operating with a fixed catalyst bed can lead to a premature costly shutdown due to blockage of flow paths.

Furthermore, a bypass of hot gas through the refractory lining can develop leading to an overheating, which may threaten safe operation of the pressure vessel and result in extensive and extensive repairs.

US patent application publication No. 2019/0218151 suggests, among others, an yttria stabilized cubic zirconia refractory brick material which exhibits high chemical resistance in reducing hot gas atmospheres containing steam. The Al₂O₃-content of the coarse-ceramic material is limited to only 0.05-6 wt. % to avoid premature wear during application, whereby the slight amount of Al₂O₃ should advantageously promote the formation of metastable tetragonal ZrO₂. However, it is known that such zirconia materials are extremely more expensive than corundum bricks. It also cannot be ruled out that the cubic zirconia phase is at least partially destabilized during use, which is accompanied by a temperature-dependent volume change that can lead to critical crack formation. A commercial use of these high-density materials as inner brick lining material is therefore not a viable option.

### SUMMARY OF THE INVENTION

The present invention is primarily aimed at providing an Al₂O₃-containing shaped and fired coarse-ceramic refractory product that exhibits both high resistance to reducing hot gases containing steam and high creep resistance at elevated temperatures.

Another object of the present invention is to provide a method for the manufacture and a particular use of the product.

### BRIEF DESCRIPTION OF THE DRAWINGS

FIGS. 1a to 3b show a microstructure of embodiments of the refractory product.

FIG. 4 shows weight loss after long-term exposure to reducing hot gases containing steam of embodiments of the refractory product compared with a conventional high fired and high purity corundum brick.

### DETAILED DESCRIPTION

The invention is based on the surprising recognition that the resistance of an Al₂O₃-containing coarse ceramic refractory product to reducing hot gases containing steam can be improved to a significant measurable effect when the bond matrix of the fired product comprises at least an yttria-containing crystalline mixed oxide with cubic modification of the ternary system Al₂O₃—Y₂O₃—ZrO₂. It was found that the bond matrix of the refractory product according to the present invention both exerts an effective protective function for the refractory product against alumina evaporation and advantageously contributes to a high thermal resistance and stability of the refractory product.

According to the present invention, a fired coarse ceramic refractory product is provided which comprises the following characteristics:
The product has a chemical composition according to which the following oxides are present in the following amounts, respectively:
Al₂O₃: at least 40.0 wt.-%; Y₂O₃: 2.0-57.0 wt.-%; ZrO₂: below 42.0 wt.-%;
the bond matrix of the product comprises at least an yttria-containing crystalline mixed oxide with cubic modification of the ternary system Al₂O₃—Y₂O₃—ZrO₂.

For the purposes of the present invention, the yttria-containing mixed oxide with cubic crystal structure is refractory yttrium-aluminium garnet (Y₃Al₅O₁₂, YAG) or refractory yttria fully stabilized Zirconia (Y—FSZ) or a mixture of both. YAG chemically consisting of 42.9 wt. % Al₂O₃ and 57.1 wt.-% Y₂O₃ is the Al₂O₃-richest compound in the binary system Y₂O₃—Al₂O₃. YAG has a high melting temperature of about 1900° C. and a similar coefficient of thermal expansion to Al₂O₃. Y—FSZ contains about 8 mol. % (about 13 wt. %) Y₂O₃ and melts at about 2680° C.

YAG and Y—FSZ as at least partial component of the bond matrix is detectable on the finished refractory product by means of X-ray powder diffraction analysis, e.g. using Rietveld-method, and/or microscopic examination of, for example, thin sections, if necessary also including the determined chemical composition of the product, e.g. measured by DIN EN ISO 12677.

In accordance with the invention, it was found out that the presence of further oxides, which may be present in the refractory product according to the invention in addition to the oxides Al₂O₃, Y₂O₃ and ZrO₂, e.g. as raw material impurities, may have a negative influence on the resistance to steam-containing reducing hot gases and/or on the hot properties. These include, for example, SiO₂, TiO₂, Fe₂O₃ and alkalis, the content of which in total should not exceed 1.5 wt.-%, preferably should not exceed 1.0 w.-%, in the finished product. In addition, it should be taken into account that HfO₂ occurs in ZrO₂ synthesized from zircon sands, e.g. by electrofusion, with a content of up to 2 wt.-%. In this respect, in a preferred embodiment, it is provided that the refractory product according to the invention comprises a chemical composition according to which the sum of the oxides SiO₂, TiO₂, Fe₂O₃, alkalis, and HfO₂ is at most 2.2 wt.-%, preferably at most 1.7 wt.-%, e.g. determined by DIN EN ISO 12677.

Accordingly, as raw material for providing the scaffolding grain of the product according to the invention, granular high purity fused corundum and/or sintered corundum with an Al₂O₃-content of >98.5 wt. %, preferably >99 wt. %, most preferably >99.5 wt. %, and with grain sizes customary for coarse ceramic products, e.g. 0-1 mm and/or 1-5 mm, are preferably used. Grain sizes are determined by sieve analyses, e.g. according to DIN 66165. According to certain non-restricted embodiments, other Al₂O₃-containing granular raw materials with aforementioned grain sizes e.g. sintered and/or fused spinel and/or sintered and/or fused YAG and/or sintered and/or fused materials of the system Al₂O₃—Y₂O₃—ZrO₂, may also be provided for the scaffolding grain of the refractory product, at least in part.

The present invitation also encompasses a process for the production of the refractory product including the step of providing a bond matrix comprising at least an yttria-containing crystalline mixed oxide with cubic modification of the ternary system Al₂O₃—Y₂O₃—ZrO₂.

According to certain non-limiting embodiments, YAG can be provided in the bond matrix of the refractory product, for example, via a reaction of Al₂O₃ and Y₂O₃ in an appropriate mixing ratio in-situ during firing of the refractory product at temperatures in the range of 1500° C. to 1800° C., preferably 1600° C. to 1760° C. The reaction to YAG proceeds via the intermediate formation of Y₄Al₂O₉ (YAM, monoclinic) and YAlO₃ (YAP, orthorhombic). In the context of the invention, in-situ formed YAG has been detected already when fired at lower temperature, e.g. 1400° C. However, it has been found that a sufficient high heat resistance and stability is provided when the product according to the invention is fired at the aforementioned higher firing temperature.

Yttria raw material is available on the market as a synthetic product with a high degree of purity whereby, in sense of the present invention, purity means the ratio of Y₂O₃-content/sum total rare earth oxides (Y₂O₃/TREO). Y₂O₃ has a cubic structure and melts at about 2410° C. According to the invention, yttrium oxide powder is used, for example, with a degree of purity of >98.5%, preferably ≥99%, most preferably ≥99.9%, whereby the sum content of non-rare earth impurities, such as Fe, Al, Ca, SO₄²⁻ and Cl⁻, is below 0.15 wt. %. The average grain size of the yttrium oxide powder used is less than 63 μm, preferably less than 25 μm, and more preferably less than 10 μm, e.g. measured by laser diffraction (d₅₀-value).

As Al₂O₃ raw material for YAG-formation, preference is given to using high purity fused alumina (fused corundum) and/or sintered alumina (sintered corundum) and/or ground calcined alumina powder available on the market, which are characterized by an Al₂O₃-content of >99 wt. %, in particular >99.5 wt. %. Whereby, in the context of the present invention, it has been found out that the Al₂O₃ raw material may be provided as powder with grain size less than 0.5 mm, preferably less than 0.1 mm, and/or grain with grain sizes customary for coarse ceramic products, e.g. 0-1 mm and/or 1-5 mm, whereby gain sizes are determined by sieve analyses, e.g. according to DIN 66165. It has been surprisingly found out that, during firing of the shaped refractory product, yttria even reacts with coarser corundum grains at their surface by formation of YAG as part of the bond matrix.

In accordance with certain non-limiting embodiments, Y—FSZ can be obtained in the bond matrix of the refractory product, via a reaction of, preferably commercially available, monoclinic and/or tetragonal ZrO₂ and Y₂O₃ powder in an appropriate mixture in-situ during firing of the refractory product at temperatures in the range of 1500° C. to 1800° C., preferably 1650° C. to 1760° C., the ZrO₂ being provided preferably in powder form with grain size less than 0.5 mm, preferably less than 0.1 mm, determined e.g. as sieve passage.

According to certain non-limiting embodiments, a mixture of YAG and Y—FSZ can be provided in the bond matrix of the refractory product, via a reaction of Al₂O₃, Y₂O₃ and ZrO₂ in an appropriate mixing ratio in-situ during firing of the refractory product in the temperature range of 1500° C. to 1800° C., preferably 1650° C. to 1760° C., using raw materials as described above. In this context, it was recognised that YAG-formation occurs only after Y—FSZ formation is complete.

In the context of the present invention, it was found that separately produced (synthetic) YAG, e.g. by solid-state reaction, or separately synthetically produced Y—FSZ, e.g. commercially available electro-fused, or a mixture of both can be provided at least proportionally in the bond matrix of the refractory product when used as a raw material preferably in powder form with grain size less than 0.5 mm, preferably less than 0.1 mm, determined e.g. as sieve passage.

According to certain non-limiting embodiments, YAG can be prepared separately, for example, by mixing yttria and alumina powder of the types described above in a suitable ratio, e.g. stoichiometric, with the addition of a suitable organic pressing and/or binding agent such as lignin sulfonates or wax emulsion, optionally in combination with water, so to form a pressable composition. This is followed by a shaping process, e.g. uniaxial pressing or extrusion, followed by firing of the shaped and dried body at a temperature above 1400° C., preferably above 1450° C. The dimensions of the fired shaped body are to be selected in such a way that the desired maximum grain size can be obtained after crushing and sieving and optionally milling.

According to another aspect of the present invention, separately produced YAG may be provided at least in part as Al₂O₃-containing scaffolding grain when used as raw material with grain sizes common for coarse ceramic products, e.g. 0.1-1 mm and/or 1-5 mm, determined e.g. by sieve analysis.

According to the invention, the Al₂O₃-containing scaffolding grain having the aforementioned grain sizes is mixed with a mixture of the YAG and/or Y—FSZ forming components, respectively with powdery YAG and/or Y—FSZ, and with a temporary binder or binder mixture, for example an organic binder such as lignin sulfonates and dextrin, and with water if required. The temporary binder and water can be added in the necessary proportions, in particular in such proportions that the prepared batch (mix) has a moist crumbly consistency. The coarse ceramic mix is shaped to give bricks. For shaping, various well-known processes may be used whereby; in particular, the complexity of desired geometric shape and number of pieces to be shaped has to be taken into account (“Handbook of Refractory Materials”, op. cit.). Where applicable, the shaped product may still be dried before firing, for example in a dryer. The brick is subsequently fired at temperatures in the range of 1500° C. to 1800° C., preferably 1650° C. to 1760° C. The firing may preferably be carried out for a duration in the range of 4 to 12 hours at the aforementioned firing temperatures.

The product according to the invention is preferably used in furnaces, reformers such as secondary steam reformers, reactors or vessels with reducing atmospheres. In this respect, it is also an object of the invention to use the product according to the invention as lining material for gasification plants, in particular as lining material for a vessel for producing hydrogen and carbon monoxide rich syngas at temperatures above 1000° C.

It is further an object of the invention to provide a vessel for the production of hydrogen and carbon monoxide rich syngas at temperatures above 1000° C. that is at least partially lined with the product according to the invention, e.g. as a wall brick and/or as the partition between the combustion zone and the catalytic zone.

In summary, the features of the present invention are:

1. A shaped and fired coarse ceramic refractory product comprising
(a) a chemical composition comprising a content of Al₂O₃: at least 40 wt.-%; Y₂O₃: 2.0-57 wt.-%; ZrO₂: below 42.0 wt.-%; and
(b) a bond matrix comprising at least an yttria-containing crystalline mixed oxide with cubic modification cubic modification of the ternary system Al₂O₃—Y₂O₃—ZrO₂.

2. Refractory product according to feature 1, wherein the yttria-containing crystalline mixed oxide with cubic crystal structure of the ternary system is yttrium-aluminium garnet (Y₃Al₅O₁₂).

3. Refractory product according to feature 1, wherein the yttria-containing crystalline mixed oxide with cubic crystal structure is yttria fully stabilized zirconia or a mixture of yttria fully stabilised zirconia and Y₃Al₅O₁₂.

4. Refractory product according to any of features 1 to 3, wherein the sum of the oxides SiO₂, TiO₂, Fe₂O₃, alkalis, and HfO₂ further contained in the product is at most 2.2 wt.-%, preferably at most 1.7 wt.-%.

5. Refractory product according to any of features 1 to 4, wherein the chemical composition comprises at least 60 wt. % of Al₂O₃.

6. Refractory product according to any of features 1 to 5, wherein the chemical composition comprises between 2.0 to 25 wt. % Y₂O₃.

7. A process for producing a shaped and fired coarse ceramic refractory comprising a chemical composition comprising a content of Al₂O₃: at least 40 wt.-%; Y₂O₃: 2.0-57 wt.-%; ZrO₂: below 42.0 wt.-%, the process comprising the step of:
providing a bond matrix comprising at least an yttria-containing crystalline mixed oxide with cubic modification of cubic modification of the ternary system Al₂O₃—Y₂O₃—ZrO₂.

8. The process according to feature 7, wherein the Y₂O₃ for providing the yttria-containing crystalline mixed oxide has a degree of purity >98.5%, such as >99% or such as 99.9% of Y₂O₃/the total sum of rare earth oxides.

9. The process according to feature 7 or 8, wherein a raw material mixture comprises granular high purity fused corundum and/or sintered corundum with an Al₂O₃-content of >98.5 wt. %, preferably >99 wt. %, most preferably >99.5 wt. %, and with grain sizes of between 0-1 mm and/or between 1-5 mm.

10. The process according to any of features 7 to 9, wherein the bond matrix is formed by firing the raw material mixture after the shaping of the raw material mixture.

11. The process according to any of features 7 to 10, wherein the average grain size of the Y₂O₃ is less than 63 μm, such as less than 25 μm or such as less than 10 μm.

12. Use of the product according to any of features 1 to 6 as a refractory material exposed to a reducing atmosphere.

13. A vessel for the production of hydrogen and carbon monoxide rich gases comprising a product according to any of claims 1 to 6.

The following examples and drawings are provided for the purpose of illustration and are not intended to restrict the scope of protection of the present invention.

### EXAMPLES

The contents of powdery and granular raw materials used for the production of the examples and a conventional comparative alumina brick (reference) are listed in Table 1. Yttria powder used had an average grain size (d₅₀) of approx. 5 μm and a purity (Y₂O₃/TREO) of 99.99%. Homogenous mixing of the components with additional approx. 0.8 wt. % lignin sulfonate and approx. 2.2 wt. % of water was done in an intensive mixer. The moist crumbly mixtures obtained in this way were pressed at a forming pressure of about 80 MPa to give bricks having a volume of about 4300 cm³ (brick height approx. 15 cm). After drying at approx. 110° C. to constant weight, the dried bricks were fired at a temperature of 1720° C. for 6 hours.

Certain properties of the fired bricks are shown in Table 1. Content of YAG and Y—FSZ was determined by X-ray powder diffraction analysis including chemical analysis. Bulk density and apparent porosity were measured according to DIN EN 993-1, cold crushing strength according to DIN EN 993-5 and, as a measure of thermal resistance and stability, creep in compression according to DIN EN 993-9.

TABLE 1

| | | Example | | | | | | |
|---|---|---|---|---|---|---|---|---|
| Item | | 1 | 2 | 3 | 4 | 5 | 6 | Reference |
| Mix (wt. %) | Fused alumina 1-3 mm | 45 | 45 | 45 | 45 | 45 | 42.5 | 45 |
| | Fused alumina 0-1 mm | 40 | 40 | 40 | 40 | 40 | 27.5 | 40 |
| | Calcined alumina 0-0.1 mm | 6.4 | 3.3 | — | — | — | — | 15 |
| | Yttria 0-0.1 mm | 8.6 | 11.8 | 15 | 5.8 | 2.1 | — | — |
| | Monoclinic ZrO₂ 0-0.1 mm | — | — | — | 9.2 | 12.9 | — | — |
| | Y-FSZ 0-0.1 mm | — | — | — | — | — | 30 | — |
| Properties | YAG (wt. %) | 15.1 | 20.7 | 26.3 | 7.7 | — | — | — |
| | Y-FSZ (wt. %) | — | — | — | 10.6 | 15 | 30 | — |
| | Al₂O₃ (wt. %) | 90.9 | 87.7 | 84.5 | 84.5 | 84.5 | 69.9 | 99.5 |
| | Y₂O₃ (wt. %) | 8.6 | 11.8 | 15.0 | 5.8 | 2.1 | 3.9 | — |
| | ZrO₂ (wt. %) | — | — | — | 8.9 | 12.4 | 25.1 | — |
| | ΣSiO₂, TiO₂, Fe₂O₃, | 0.4 | 0.3 | 0.3 | 0.7 | 0.8 | 0.9 | 0.4 |
| | alkalis, HfO₂ (wt. %) | | | | | | | |
| | Bulk density (g/cm³) | 3.26 | 3.25 | 3.24 | 3.30 | 3.28 | 3.40 | 3.24 |
| | Apparent porosity (%) | 18.8 | 19.9 | 20.6 | 19.9 | 20.5 | 22.4 | 18.0 |
| | Cold crushing strength | 50 | 70 | 72 | 61 | 50 | 37 | 112 |
| | (MPa) | | | | | | | |
| | Creep at 1550° C., load | — | — | — | — | — | | |
| | 0.2 MPa; | | | | | | | |
| | Z₅₋₂₅ (%) | 0.19 | 0.19 | 0.09 | 0.10 | 0.21 | −0.15 | −0.21 |

It has been found that the fired bricks according to the invention display excellent creep behaviour (Z₅₋₂₅-value, deformation between 25 h and 5 h test period) which is at least equal to a conventional high-fired and high-purity corundum brick (reference).

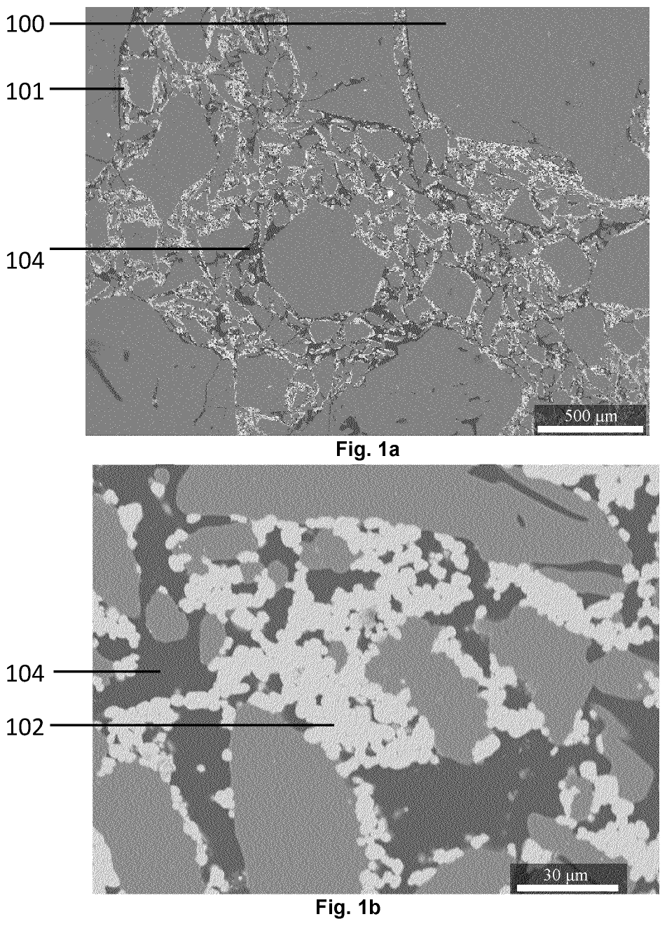

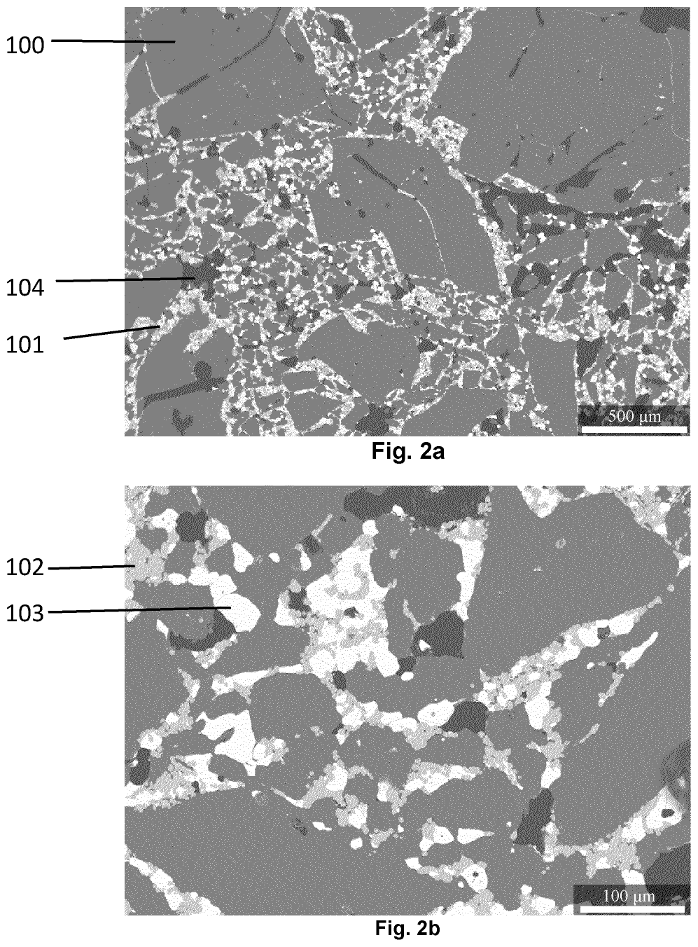

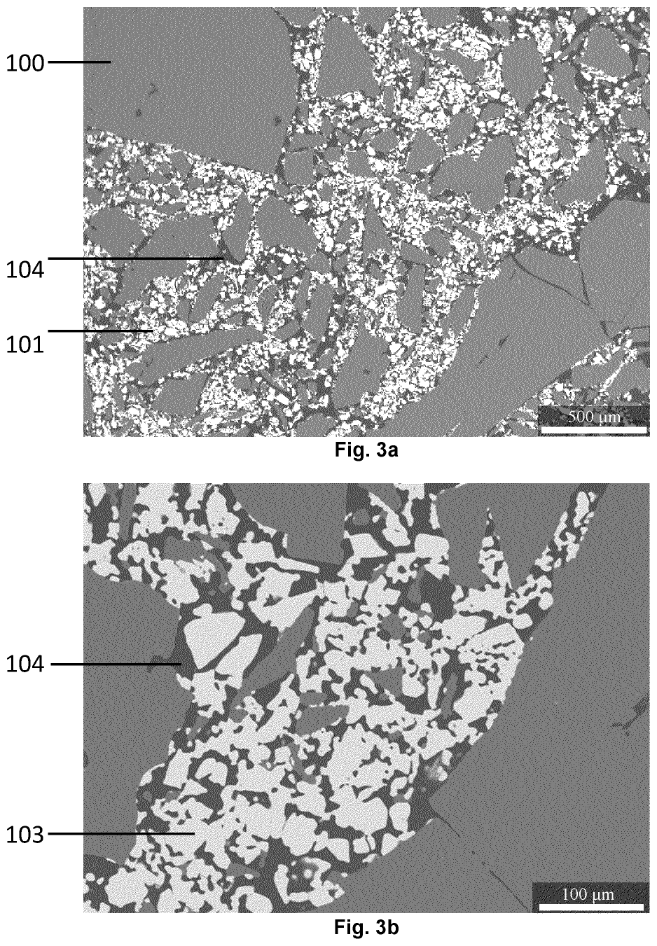

FIGS. 1a and 1b show the microstructure of inventive example 1, FIGS. 2a and 2b of inventive example 4, and FIGS. 3a and 3b of inventive example 6. It can be seen the scaffolding grain (100), bond matrix (101) containing YAG (102) or Y—FSZ (103) or both as well as open pores (104).

In order to quantitatively evaluate the improved resistance to reducing hot gases containing steam, hydrogen and carbon oxides, bricks according to the invention produced as described in example 1 to 6 were subjected to a comparative practical trial in the combustion chamber of a vessel for industrial production of syngas using the catalytic process for about 7 months. The maximum application temperature was at about 1200° C. A conventional high-purity corundum brick produced as described above (reference) acted as the comparative material. The weight of all bricks to be tested was measured before and after the trial and the respective percent weight loss was determined. Based on this, the comparative percent weight loss (CWL) was calculated according to the following equation:

CWL (%)=(weight loss of example (%)·100%)/(weight loss of reference (%)).

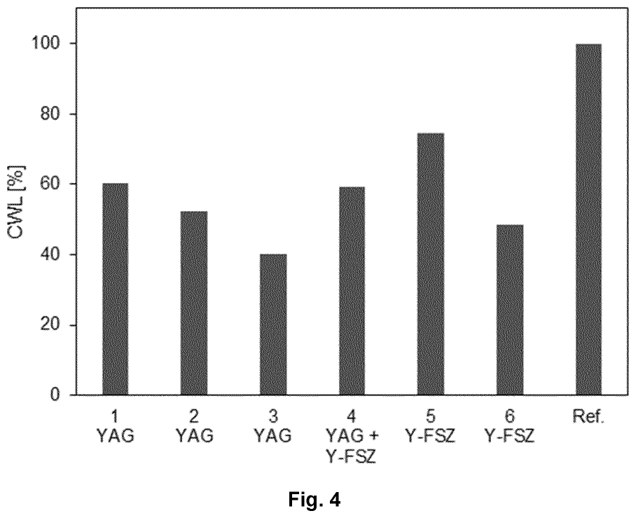

The results are listed in Table 2 and are also illustrated in the graph of FIG. 4.

TABLE 2

| | Example | | | | | | |
|---|---|---|---|---|---|---|---|
| Item | 1 | 2 | 3 | 4 | 5 | 6 | Reference |
| Comparative | 60.2 | 52.5 | 40.1 | 59.4 | 74.6 | 48.7 | 100 |
| weight loss | | | | | | | |
| CWL (%) | | | | | | | |

The results shown in table 2 reflect the clear superiority of the product according to the invention over high-purity corundum bricks in terms of resistance to hot gases containing steam, hydrogen and carbon oxides. Regarding examples 4 to 6, a trial-related destabilization of the cubic zirconia phase could not be detected.

It has also been unexpectedly discovered that the thermal conductivity of the product according to the invention is noticeably lower than that of commercially available corundum bricks that, among other things, has a positive effect on energy saving.

1. A shaped and fired coarse ceramic refractory product comprising
(a) a chemical composition comprising a content of Al₂O₃: at least 40 wt.-%; Y₂O₃: 2.0-57 wt.-%; ZrO₂: below 42.0 wt.-%; and
(b) a bond matrix comprising at least an yttria-containing crystalline mixed oxide with cubic modification cubic modification of the ternary system Al₂O₃—Y₂O₃—ZrO₂.

2. Refractory product according to claim 1, wherein the yttria-containing crystalline mixed oxide with cubic crystal structure of the ternary system is yttrium-aluminium garnet (Y₃Al₅O₁₂).

3. Refractory product according to claim 1, wherein the yttria-containing crystalline mixed oxide with cubic crystal structure is yttria fully stabilized zirconia or a mixture of yttria fully stabilized zirconia and Y₃Al₅O₁₂.

4. Refractory product according to claim 1, any of claims 1 to 3, wherein the sum of the oxides SiO₂, TiO₂, Fe₂O₃, alkalis, and HfO₂ further contained in the product is at most 2.2 wt.-%, preferably at most 1.7 wt.-%.

5. Refractory product according to claim 1, wherein the chemical composition comprises at least 60 wt. % of Al₂O₃.

6. Refractory product according to claim 1, wherein the chemical composition comprises between 2.0 to 25 wt. % Y₂O₃.

7. A process for producing a shaped and fired coarse ceramic refractory comprising a chemical composition comprising a content of Al₂O₃: at least 40 wt.-%; Y₂O₃: 2.0-57 wt.-%; ZrO₂: below 42.0 wt.-%, the process comprising the step of:
providing a bond matrix comprising at least an yttria-containing crystalline mixed oxide with cubic modification of cubic modification of the ternary system Al₂O₃—Y₂O₃—ZrO₂.

8. The process according to claim 7, wherein the Y₂O₃ for providing the yttria-containing crystalline mixed oxide has a degree of purity >98.5% of Y₂O₃/the total sum of rare earth oxides.

9. The process according to claim 7, wherein a raw material mixture comprises granular high purity fused corundum and/or sintered corundum with an Al₂O₃-content of >98.5 wt. %, and with grain sizes of between 0-1 mm and/or between 1-5 mm.

10. The process according to claim 7, wherein the bond matrix is formed by firing the raw material mixture after the shaping of the raw material mixture.

11. The process according to claim 7, wherein the average grain size of the Y₂O₃ is less than 63 μm.

12. A process comprising the step of using the product according to claim 1 as a refractory material exposed to a reducing atmosphere.

13. A vessel for the production of hydrogen and carbon monoxide rich gases comprising a product according to claim 1.
